(19) United States
(12) Patent Application Publication
(10) Pub. No.: US 2014/0333786 A1
(43) Pub. Date: Nov. 13, 2014

(54) SYSTEM AND METHOD FOR REMOTELY CREATING AND PROCESSING MEDIA FILES

(71) Applicant: HON HAI PRECISION INDUSTRY CO., LTD., New Taipei (TW)

(72) Inventor: HO-LEUNG CHEUNG, Santa Clara, CA (US)

(73) Assignee: HON HAI PRECISION INDUSTRY CO., LTD., New Taipei (TW)

(21) Appl. No.: 14/270,371

(22) Filed: May 6, 2014

(30) Foreign Application Priority Data
May 9, 2013 (CN) 2013101670608

(51) Int. Cl. H04N 5/232

(52) U.S. Cl. CPC H04N 5/23206; H04N 5/23222; H04N 5/23216
USPC 348/211.3

(57) ABSTRACT

A system for processing media files is provided. The system includes an identity assignment module, a positioning module, a camera management module, an association module, and an output module. The identity assignment module is used to assign an identification number to an electronic device. The positioning module is used to determine a geographical location of the electronic device. The camera management module is used to control the camera device to take photos or record videos wherein the camera device is in a predetermined location where the electronic device is located in. The association module is used to associate the identification number with the captured photos or the recorded videos. The output module is used to output the captured photos or the recorded videos in response to a user input. A method for processing media files is also provided.

### FIELD

The present disclosure relates to a system for remotely creating and processing media files and a method using the same.

### BACKGROUND

Tourists may like to take photos for themselves in the scene when travelling in a scenic spot. A tourist who is traveling alone will need to ask others to help to take photos.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts or sections throughout the drawings.

FIG. 1 illustrates a block diagram of an embodiment of a system for remotely creating and processing media files and a running environment of the system.

FIG. 2 illustrates a flowchart of an embodiment of a method for remotely creating and processing media files.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one”.

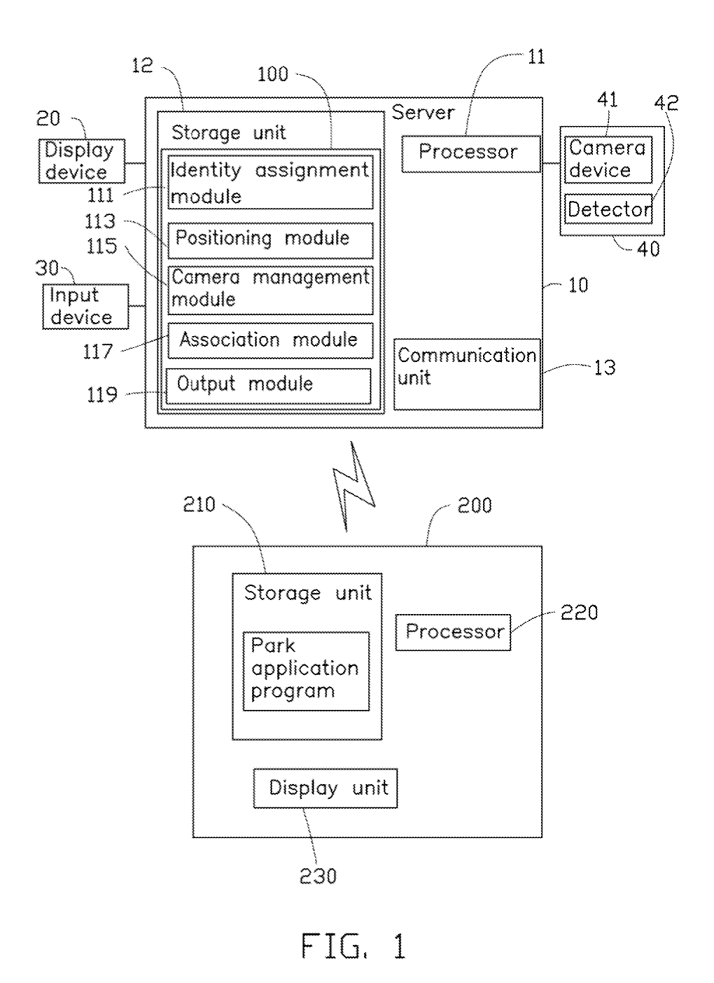

FIG. 1 illustrates a block diagram of an embodiment of a system 100 for remotely creating and processing media files and a running environment of the system 100. The system 100 is executed by a server 10. The server 10 is connected to at least one display device 20, at least one input device 30, and at least one camera device 40. The media files can include photos taken by the camera device 40 and videos recorded by the camera device 40. The input device 30 inputs information. The display device 20 displays information, the photos and the videos. The server 10 can include a processor 11, a storage unit 12, and a communication unit 13. The storage unit 12 stores the system 100. In the embodiment, the system 100 includes a number of modules, which are a collection of software instructions and are executed by the processor 11 of the server 10. The modules of the system 100 can include an identity assignment module 111, a positioning module 113, a camera management module 115, an association module 117, and an output module 119. The communication unit 13 provides communication between the server 10 and an electronic device 200, such as portable computer, or mobile phone, a tablet computer, or other electronic device.

As shown in FIG. 1, the electronic device 200 includes a storage unit 210, a processor 220, and a display unit 230. In the embodiment, the storage units 12, 210 can be hard disks, compact disks, or flash memories. The processors 11, 220 can be central processing units, digital signal processors, or single chips.

The identity assignment module 111 assigns an identification number (ID) to the electronic device 200. For example, the system 100 can be applied in an amusement park, and the display device 20, the input device 30 and the camera device 40 can be set at many predetermined locations of the amusement park. Each display device 20, each input device 30, and each camera device 40 are set nearby each other and at one predetermined location of the amusement park. The user may receive a guide book when coming into the amusement park. The guide book can include a printed code, such as a two-dimensional Quick Response code, or a bar code or other code. The electronic device 200 can scan the code to obtain a character string and download a park application program from a specific website according to a link contained in the code. The park application program can be installed in the electronic device 200 and stored in the storage unit 210 of the electronic device 200 in response to user operation. After the processor 220 of the electronic device 200 runs the park application program in response to user operation, the electronic device 200 transmits the character string to the server 10 via a network, such as internet, a wireless network which may include WIFI or BLUETOOTH, a telecommunication network including a general packet radio service (GPRS) network, a code division multiple access (CDMA) network, or a broadcasting network.

The identity assignment module 111 takes the character string as an ID of the electronic device 200 and assigns the ID to the electronic device 200. In the embodiment, the identity assignment module 111 assigns the ID to the electronic device 200 as follows: the identity assignment module 111 associates the ID with a communication address of the electronic device 200, such as a telephone number of the electronic device. If the electronic device 200 is a mobile phone, the electronic device 200 can send a short message which has a predetermined format to the server 10, and the identity assignment module 111 can assign an ID to the electronic device 100 in response to the received short message, thus associating the ID with an telephone number of the electronic device 200. Furthermore, the ID can be stored in the storage unit 210 of the electronic device 200.

The positioning module 113 determines a geographical location of the electronic device 200 in real time, and determines whether the electronic device 200 is located in the range of view of one camera device 40. In the embodiment, the positioning module 113 locates the geographical location of the electronic device 200 according to the communication address of the electronic device 200. In another embodiment, the park application program can obtain the geographical location of the electronic device 200 at intervals, and transmits the obtained geographical location and the ID of the electronic device 200 to the server 10, so that the positioning module 113 can determine the geographical location of the electronic device 200 in real time.

In the embodiment, the storage unit 12 of the server 10 also stores geographical locations of all camera devices 40 connected to the server 10. The positioning module 113 determines whether the electronic device 200 is located in the range of view of one camera device 40 by comparing the determined geographical location of the electronic device 200 with the geographical location of each camera device 40. The positioning module 113 determines that the electronic device 200 is located in the range of view of one camera device 40 when it has determined that a distance between the geographical location of the electronic device 200 and the geographical location of the camera device 40 is less than a predetermined value, such as five meters.

The camera management module 115 controls the camera device 40 which is nearest the electronic device 200 to take photos or record videos when the positioning module 113 determines that the electronic device 200 is located in the range of view of the camera device 40. In one embodiment, the camera device 40 can take photos or record videos at any time no matter whether there is any electronic device located in the range of view of the camera device 40.

In detail, the camera management module 115 displays a first dialog box on the electronic device 200 to ask the user if photos or videos via the camera device 40 are required when the electronic device 200 is found to be located in the range of the view of one camera device 40, and controls the camera device 40 to take photos or record videos which is nearest to the electronic device 200 after the user has indicated that photos or videos via the camera device 40 are required. Thus, the user can turn to face the camera device 40 and adjust his/her posture to get wanted photos or videos after choosing to take photos or record videos via the camera device 40. In the embodiment, each display device 20 is set nearby one camera device 40, and photos captured or videos recorded by the camera device 40 can be transmitted to the nearby display device 20 and displayed on the display device 20, thus the user can determine whether the photos captured or videos recorded by the camera device 40 satisfy him/her and adjust him/her posture after viewing the photos or videos displayed on the display device 20.

In the embodiments, when the positioning module 113 determines that the electronic device 200 is located in the range of the view of one camera device 40, the positioning module 113 transmits a signal to the electronic device 200 to inform the user that the user is located in the range of the view of the camera device 40.

In another embodiment, when the electronic device 200 is located in a predetermined location, the park application program generates a signal, for example, a spoken message or other audible warning, or a vibration alert to prompt the user that the user is located in a range of the view of the camera device 40.

In another embodiment, the positioning module 113 further generates a second dialog box to ask the user if he/she wishes to establish a communication connection between the electronic device 200 and the camera device 40. After a communication connection between the electronic device 200 and the camera device 40 is established, the photos captured by the camera device 40 or the videos recorded by the camera device 40 can be transmitted directly to the electronic device 200 and displayed on the electronic device 200.

In another embodiment, the second dialog box is provided by the park application program.

In the embodiment, the camera management module 115 further generates a third dialog box on the electronic device 200 to ask the user whether still photos or moving videos are needed via the camera device 40. The camera management module 115 controls the camera device 40 to take still photos or moving videos according to a selection of the user.

In the embodiment, the camera management module 115 further generates a fourth dialog box to ask the user whether the aim of the camera device 40 needs to be adjusted. When adjustment of the aim or current pointing direction of the camera device 40 is selected, the camera management module 115 generates a command to control the camera device 40 to rotate to adjust the aim of the camera device 40.

In the embodiment, the user can respond to the first to fourth dialog boxes via the input device 30 near the camera device 40 or via the electronic device 200.

The association module 117 establishes a mapping relationship between the photos captured or videos recorded by the camera device 40 and the ID of the electronic device 200, namely the association module 117 associates the photos captured or the videos recorded by the camera device 40 with the ID of the electronic device 200.

The output module 119 is used for outputting the photos or the videos associated with the ID of the electronic device 200 to the electronic device 200 or to a user-specified storage device connected to the electronic device 200, such as portable hard disk according to the communication address of the electronic device 200 with the ID in response to an input operation, such as an operation of inputting the ID via the input device 30. According to what is required, the user can preview the photos or the videos displayed on the display device 20, and then select some photos or grab some pictures from the recorded videos or grab a part of videos from the recorded videos which the user prefers to receive via the input device 30 near the display device 20, and the output module 119 outputs the photos which are selected by the user or the pictures grabbed by the user or the part of videos grabbed from the videos by the user to the electronic device 200 or to the user specified storage device.

In the embodiment, the camera device 40 can include a camera 41 and a detector 42. The detector 42 detects ambient light level and/or ambient humidity. When the detector 42 detects that the ambient light level is less than a first predetermined value and/or the ambient humidity is higher than a second predetermined value, the camera management module 115 transmits the corresponding information to the electronic device 200 to generate a warning to the user that the quality of the photo or the video may be reduced because of the influence of the low ambient light level and/or the high ambient humidity. In the embodiment, the camera management module 115 further generates a fifth dialog box to ask the user whether the photos taken by the camera device 40 or the videos recorded by the camera device 40 should be discarded. In another embodiment, the camera management module 115 further discards the photos or the videos when determined that the ambient light level is less than a first predetermined value and/or the ambient humidity is higher than a second predetermined value.

In other embodiments, the second dialog box, the third dialog box, the fourth dialog box, and the fifth dialog box can also be provided by the park application program.

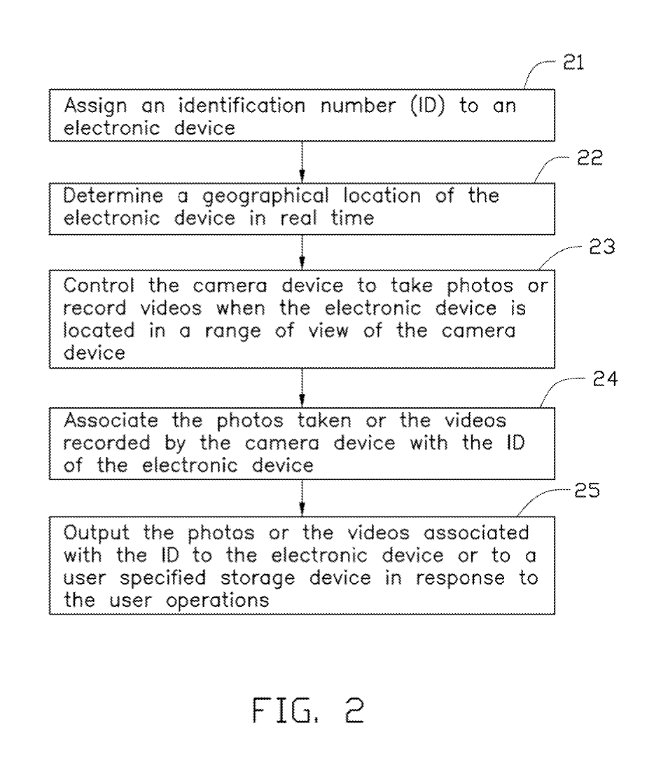

FIG. 2 illustrates a flowchart of an embodiment of a method for processing media files.

In block 21, the identity assignment module assigns an identification number (ID) to the electronic device.

In block 22, the positioning module determines a geographical location of the electronic device in real time.

In block 23, the camera management module controls the camera device to take photos or record videos when the electronic device is located in a range of view of the camera device.

In block 24, the association module associates the photos taken or videos recorded by the camera device with the ID of the electronic device.

In block 25, the output module outputs the photos or videos associated with the ID to the electronic device or to the user-specified storage device in response to the user operations.

Although the present disclosure has been specifically described on the basis of various embodiments thereof, the disclosure is not to be construed as being limited thereto. Various changes or modifications may be made to the embodiments without departing from the scope and spirit of the disclosure.

What is claimed is:

1. A system for processing media files, running in a server being coupled to at least one display device, at least one input device, and at least one camera device, the system comprising:
a plurality of modules which are instructions executed by a processor of the server, the plurality of modules comprising:
an identity assignment module to assign an identification number to an electronic device when the electronic device communicates with the server;
a positioning module to determine a geographical location of the electronic device and determine whether the electronic device is located in a range of view of one camera device;
a camera management module to control the camera device to take photos or record videos when the electronic device is located in the range of view of the camera device;
an association module to associate the identification number with the photos taken or videos recorded by the camera device; and
an output module to output the photos or videos associated with the identification number in response to a user input via the input device.

2. The system as described in claim 1, wherein the positioning module is configured to locate the geographical location of the electronic device according to communication address of the electronic device.

3. The system as described in claim 1, wherein the positioning module is configured to determine the geographical location of the electronic device by receiving geographical location of the electronic device determined by the electronic device in real time

4. The system as described in claim 1, wherein the positioning module determines whether the electronic device is located in the range of view of one camera device by comparing the determined geographical location of the electronic device with geographical locations of each camera device stored in a storage unit of the server, and determines the electronic device is located in the range of view of one camera device when determining that a distance between the geographical location of the electronic device and the geographical location of the camera device is less than a predetermined value.

5. The system as described in claim 1, wherein the camera management module is further configured to display a first dialog box on the electronic device to ask user if photos or videos via the camera device are required when the electronic device is found to be located in the range of view of one camera device, and control the camera device which is nearest the electronic device to take photos or record videos after the user has indicated that photos or videos via the camera device are required.

6. The system as described in claim 5, wherein the camera management module is further configured to generate a second dialog box on the electronic device to ask the user still photos or moving videos are needed via the camera device, and to control the camera device to take still photos or moving videos according to a selection of the user.

7. The system as described in claim 1, wherein the camera management module is further configured to generate a third dialog box to ask the user whether an aim of the camera device needs to be adjusted, and to generate a command to control the camera device to rotate to adjust the aim of the camera device when adjustment of the aim of the camera device is selected according to a selection of the user.

8. A method for processing media files, applied in a server connected to at least one display device and at least one camera device, the method comprising:
assigning an identification number to an electronic device when the electronic device communicates with a server;
determining a geographical location of the electronic device in real time;
determining whether the electronic device is located in a range of view of one camera device;
controlling the camera device to take photos or record videos when the electronic device is located in the range of view of one camera device;
associating the photos taken or the videos recorded by the camera device and the identification number of the electronic device;
outputting the photos or the videos associated with the identification number to the electronic device.

9. The method as described in claim 8, wherein the step of determining a geographical location of the electronic device in real time comprises:
determining the geographical location of the electronic device by receiving geographical location of the electronic device determined by the electronic device

10. The method as described in claim 8, wherein the step of determining a geographical location of the electronic device in real time comprises:
determining the geographical location of the electronic device in real time according to a communication address of the electronic device.

11. The method as described in claim 8, wherein the step of determining whether the electronic device is located in a range of view of one camera device comprises:
determining whether the electronic device is located in the range of view of one camera device by comparing the determined geographical location of the electronic device with geographical locations of each camera device stored in a storage unit of the server; and
determining the electronic device is located in the range of view of one camera device when determining that a distance between the geographical location of the electronic device and the geographical location of the camera device is less than a predetermined value.

12. The method as described in claim 8, wherein the step of controlling the camera device to take photos or record videos when the electronic device is located in the range of view of one camera device comprises:
displaying a first dialog box on the electronic device to ask user whether to take photos or record videos via the camera device when the electronic device is located in the range of view of one camera device, and
turning on the camera device and controlling the camera device to take photos or record videos after the user selects to take photos or record videos via the input device.

13. The method as described in claim 8, further comprising:
generating a second dialog box on the electronic device to ask the user still photos or moving videos via the camera device are required, and
controlling the camera device to take still photos or moving videos according to a selection of the user.

14. The method as described in claim 8, further comprising:
generating a third dialog box to ask the user whether an aim of the camera device is needed to be adjusted, and
generating a command to control the camera device to rotate to adjust the aim of the camera device when the aim of the camera device is selected to be adjusted according to a selection of the user.
